(19) United States
(12) Patent Application Publication
(10) Pub. No.: US 2008/0160841 A1
(43) Pub. Date: Jul. 3, 2008

(54) Electrical contact used in an electrical socket

(75) Inventors: Igor Polnyi, Aurora, IL (US); Chi-Nan Liao, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/648,479

(22) Filed: Dec. 28, 2006

(51) Int. Cl. H01R 13/11

(52) U.S. Cl. 439/842

(57) ABSTRACT

An electrical contact (1) comprises a retention portion (11), a contact engaging portion (12) extending upward away from the retention portion ( ), and a lower portion (13) extending from the retention portion (11), wherein the contact engaging portion (12) is formed with an embossed portion (14), which makes the contact (1) have a preferred engaging function and an improved current conducting feature.

### BACKGROUND OF THE INVENTION

1. Field of the Invention

The present invention relates to electrical contacts, and more particularly to an electrical contact with a preferred engaging function.

2. Background of the Invention

Electrical contacts are widely used in electrical socket connector to electrically bridge two electrical interfaces such as an electrical substrate, e.g. a PCB and an integrated circuit (IC) package, e.g. a central processing unit (CPU).

Referring to FIG. 1, a typical electrical contact 1′ includes a main body 11′, a solder tail 12′, an upright head portion 13′ and a spring arm 14′ extends from a top end of the main body 11′, and a resilient arm 141′ formed at a free end of the spring arm 14′, a contacting portion 143′ is defined on a distal end of the resilient arm 141′ for contacting with the chip module wherein the head portion 13′ and the spring arm 14′ are situated at two opposite sides of the central line of the main body 11′, offsetting the central line a distance, respectively. A spacing is defined between the spring arm 14′ and the head 13′. However, the contacting portion 143′ generally is in a shape a columnar shape, which is difficult to contact with the conducting pad of the chip module and limits engaging shape of the contacting pads attached on the chip module.

What is needed, thereby, is a new electrical contact able to provide a preferred contacting shape and a good contacting stability.

### SUMMARY OF THE INVENTION

An electrical contact according to a preferred embodiment of the present invention may include a retention portion, a solder portion bending from a bottom edge of the retention portion, a contact portion formed at a topmost end of the retention portion. The contact portion is configured as a spherical type head, which makes the contact have a preferred engaging function and an improved current conducting feature.

### BRIEF DESCRIPTION OF THE DRAWINGS

FIG. 1 is an isometric view of a conventional electrical contact;

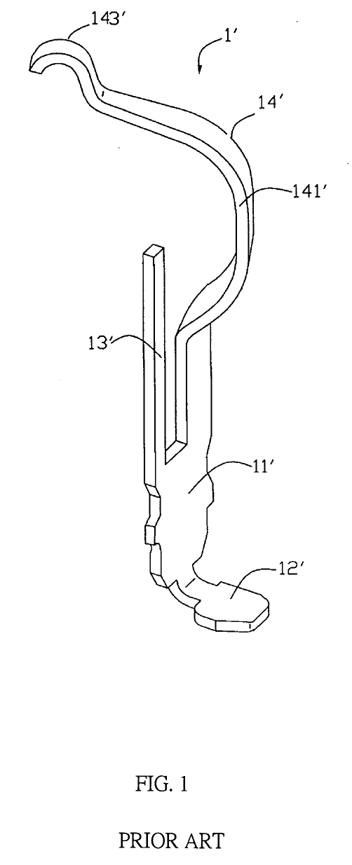

FIG. 2 is an isometric view of an electrical contact in accordance with a preferred embodiment of the present invention;

### DETAILED DESCRIPTION OF THE PREFERRED EMBODIMENT OF THE INVENTION

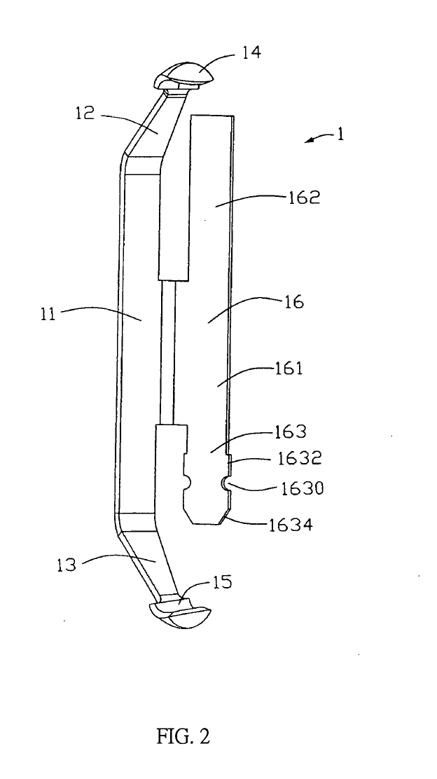

Referring to FIG. 2, an electrical contact 1 according to a preferred embodiment of the present invention is shown. The contact 1 is mainly used in an electrical socket, such as an LGA (Land Grid Array) socket (not shown), and adapted to electrically connect two interfaces, such as an IC package and a PCB (not shown), but not limited thereto.

Referring also to FIG. 2, the contact 1 is formed from conductive material and has a vertical plate-like retention portion 11 for body in a corresponding passageway of the socket generally with a symmetrical central line (not labeled). The retention portion 11 symmetrically extends a pair of spring arms from two opposite end thereof comprising a first spring arm 12 and a second spring arm 13.

For more reliable position of the contact 1 in the passage of the socket, an upright head portion 16 extends from a top end of the retention portion. In this preferred embodiment, the head portion 16 is angled with the retention portion 11 and has a generally elongate plate-like configuration. It should be understood that the head portion 16 may be figured to have other configurations, as long as it can be fit for fixing the contact 1 more reliably in the socket. The head portion 16 comprises a body portion 161 extending from a sidewall of the retention portion 11, a securing portion 163 extending downwardly from the body portion 161 and a leading portion 162 extending from a distal end of the body portion 161. The securing portion 163 defines a pair of slant surfaces 1634 on a lower end thereof and a pair of concave 1630 above the slant surfaces on two lateral sides thereof. In addition, the securing portion 163 comprises a number of barbs 1632 extending from two opposite sides thereof for engaging with the housing.

A tail portion 15 curvedly and downwardly extends from the second spring portion 13 and has a spherical type head for contacting with the printed circuit board. The tail 15 is used to establish electrical connecting between the contact and the PCB.

An contacting portion 14 formed at a distal end of the first spring arm 12, being at a topmost part of the contact 1, for electrically engagingly mating with a corresponding conductive pad of the IC package. In this preferred embodiment, the contact portion 14 has an arced or curved dish configuration, which can improve the contacting engagement between the contact 1 and the chip module, hence enhancing the stability of electrical connection between the chip module and the printed circuit board.

In use, the contact 1 is received in an insulative housing of the socket which serves to electrically connect the IC package and the PCB. The soldering portion 15 is electrically soldered to the PCB. The spring arms 12, 13 produces resilient deformation by an exterior force acted on the contact 1. The contacting portion 14 urges and mates with a corresponding conductive pad of the IC package through elastic force generated by the resilient deformation of the spring arms 12, 13. Thus, the electrical connection between the IC package and the PCB is established.

In the preferred embodiment, as the contact 1 has a contacting portion 14 and a tail portion 15 both having a semi-spherical shape able to improve a bigger surface and spherical shape which improves the engaging function between the contact and the chip module. Therefore, As a result, the contact 1 has a preferred electrical feature and mating character, compared to the typical contact 1.

While preferred embodiment in accordance with the present invention have been shown and described, equivalent modifications and changes known to persons skilled in the art according to the spirit of the present invention are considered within the scope of the present invention as defined in the appended claims.

1. An electrical contact comprising:
a retention portion extending in a upright direction;
a pair of arms symmetrically substantially extending from the retention portion, comprising a first spring arm and a second spring arm;
wherein the free ends of the first spring arm and second spring arm are formed with a spherical portion respectively; wherein
said spherical portion is essentially of an arced or curved dish-like configuration, wherein the spherical portion defines a diameter which is larger than a width of the corresponding spring arm at the corresponding free end.

2. (canceled)

3. The electrical contact as claimed in claim 1, further comprising a head portion extending from the retention portion.

4. The electrical contact as claimed in claim 3, the head portion extends from a lateral side of the retention portion and is angled with the retention portion.

5. The electrical contact as claimed in claim 4, wherein the head portion defines a body portion connecting with the retention portion, a securing portion extending downwardly from the body portion, and a leading portion upwardly extending from a top end of the body potion.

6. The electrical contact as claimed in claim 4, wherein the securing portion defines a number of barbs on sides thereof.

7. The electrical contact as claimed in claim 6, wherein the securing portion further defines a pair of concaves on the sides thereof.

8. The electrical contact as claimed in claim 7, wherein the securing portion defines a pair of slant surfaces on a top end thereof.

9. An electrical contact comprising:
a retention portion extending in a upright direction;
a head portion extending from the retention portion and located by one side of the retention portion in an angled manner;
a pair of arms symmetrically substantially extending from the retention portion, comprising a first spring arm and a second spring arm;
a tail portion curvedly and downwardly extends from the second spring portion having a embossed head, and an contacting portion formed at a distal end of the first spring ann having an embossed head and being essentially of an arced or curve dish-like configuration wherein a diameter of said contacting portion is larger than a width of said first spring ann at said distal end.

10. The electrical contact as claimed in claims 9, wherein the head portion includes a securing portion at a bottom end and leading portion at a top end.

11. An electrical contact comprising:
a retention portion;
a rail portion extending downwardly from a bottom of the retention portion and being adapted for electrically engaging with an electrical component;
a head portion extending upwardly from a side edge of the retention portion comprising a body portion which has a smooth edge without interference function, a securing portion vertically aligned with the body portion and extending from a lower end of the body portion, and a leading portion vertically aligned with the body portion and extending from an upper end of the body portion;
a contacting portion extending from a top end of a spring arm which extends from the retention portion, and said contacting portion being of an arced or curved dish-like configuration and defining a diameter larger than a width of a joint of said spring arm where the contacting portion is located;
wherein the securing portion and the leading portion arc spaced far away the retention portion respectively.

12. The electrical contact as claimed in claim 11, wherein the contacting portion defines an embossed head.

13. The electrical connector as claimed in claim 11, wherein the securing portion terminates at a level where a junction area of said retention portion and the tail portion is located, while the leading portion extends above a level where a junction area of said retention portion and the contacting portion is located.

14. The electrical connector as claimed in claim 13, wherein the contacting portion extends away from the retention portion beyond the leading portion in a vertical direction, and the tail portion extends away from the retention portion beyond the securing portion in said vertical direction.

15. The electrical connector as claimed in claim 11, wherein a junction of said retention portion and the head portion in a transverse direction defines a level, and an interference fit occurs only below said level.
